(19) United States
(12) Patent Application Publication
(10) Pub. No.: US 2025/0356395 A1
(43) Pub. Date: Nov. 20, 2025

(54) Content Group Generation for Content Delivery Campaigns

(71) Applicant: Google LLC, Mountain View, CA (US)

(72) Inventors: Sandeep Atluri, Sunnyvale, CA (US); Xiaolan Zhou, Los Altos, CA (US); Xu He, Sunnyvale, CA (US); JYoung S Kim, Sunnyvale, CA (US)

(21) Appl. No.: 18/921,710

(22) Filed: Oct. 21, 2024

Related U.S. Application Data
(60) Provisional application No. 63/649,617, filed on May 20, 2024.

(51) Int. Cl. G06Q 30/0251; G06F 16/33

(52) U.S. Cl. CPC G06Q 30/0256; G06F 16/3334

(57) ABSTRACT

Methods, systems, and apparatus, including computer-readable storage media for content group generation for a content delivery campaign. Content groups are generated from a resource identifier and a description. Digital content items are created for each content group, including digital content from the resource identifier and the description, as well as new digital content items. Candidate content groups are ranked according to request coverage gain and optionally one or more other ranking criteria. Request coverage gain is a measure of how much more request coverage is gained through keywords of one content group relative to the request coverage of one or more other content groups. By ranking according to request coverage gain, the selected candidate content groups are differentiated relative to one another, capturing potential content requests that would otherwise be missed by a campaign of content groups not selected based on request coverage gain.

### CROSS-REFERENCE TO RELATED APPLICATIONS

This application claims the benefit under 35 U.S.C. § 119(c) of the filing date of U.S. Patent Application No. 63/649,617, for CONTENT GROUP GENERATION FOR CONTENT DELIVERY CAMPAIGNS, which was filed on May 20, 2024, and which is incorporated here by reference.

### BACKGROUND

A campaign management platform manages and serves digital content to user computing devices of users. The user computing devices form an audience of computing devices targeted for receiving the digital content. Content delivery and management is organized into campaigns, which can be divided into one or more content groups. Each content group includes a keyword set and digital content items. The campaign management platform serves the digital content items in response to requests, such as queries, for content responsive to the keywords in the keyword set of the corresponding content group. A campaign management platform can track the performance of various digital content campaigns, providing analyses of current performance according to different metrics, as well as predicting the effect of future performance of a content delivery campaign when different characteristics of the campaign are changed.

### BRIEF SUMMARY

Aspects of the disclosure are directed to content group generation for a campaign from a resource identifier and a description. Digital content items are created for each content group, including digital content from the resource identifier and the description, as well as new digital content items generated using a generative model or another type of artificial intelligence (AI) model. An AI model generates a keyword set for each content group describing or otherwise corresponding to a theme identified in the digital content from the resource identifier and description. The candidate content groups are ranked according to request coverage gain and optionally one or more other ranking criteria. Request coverage is a measure of the responsiveness of keywords of a content group to requests for content. Request coverage gain is a measure of how much more request coverage is gained through keywords of one content group relative to the request coverage of one or more other content groups. For example, a content group with a positive request coverage gain that is added to a campaign will increase the total coverage the campaign has in responding to content requests.

By ranking according to request coverage gain, the selected candidate content groups are differentiated relative to one another, capturing potential content requests that would otherwise be missed by a campaign of content groups not selected based on request coverage gain. Ranking by request coverage alone, without accounting for the relative gain between other content groups in a campaign, can result in overlapping content groups that result in less total request coverage by a campaign. Improving total request coverage can improve the accuracy of serving content to a target audience of computing devices, as more devices requesting the content are served content responsive to their requests. Campaign management platforms that serve digital content more accurately perform their functions with fewer wasted computing resources, e.g., fewer redundant transmissions of data, resulting in reduced consumption of power by avoiding computations or operations needed to serve the redundant digital content.

### BRIEF DESCRIPTION OF THE DRAWINGS

FIG. 1A is an example illustration depicting total request coverage by a campaign of content groups generated without ranking by request coverage gain.

FIG. 1B is an example illustration depicting total request coverage by a campaign of content groups generated with ranking by request coverage gain, according to aspects of the disclosure.

FIG. 2 is a block diagram of an example content group generation system, according to aspects of the disclosure.

FIG. 3 is an example user interface for providing candidate content groups for user confirmation, according to aspects of the disclosure.

FIG. 4 is a flow diagram of an example process for generating content groups for a campaign, according to aspects of the disclosure.

FIG. 5 is a flow diagram of an example process for ranking content groups according to request coverage gain, according to aspects of the disclosure.

FIG. 6 is a block diagram illustrating one or more models, such as for deployment in a datacenter housing a hardware accelerator on which the deployed models will execute for content group generation.

FIG. 7 is a block diagram of an example computing environment for implementing the content group generation system.

### DETAILED DESCRIPTION

### Overview

Aspects of the disclosure are directed to content group generation for a digital content campaign based on resource identifier and a description. The resource identifier can be a uniform resource locator (URL) identifying a source of digital content, such as a landing web page. The description can be, for example, a natural language description of digital content at the resource identifier or a description of the author or provider of the digital content. One or more candidate content groups are generated for inclusion in a campaign to provide digital content related to the resource identifier and the description.

A content group generation system implemented according to aspects of the disclosure generates content groups corresponding to different themes. The system identifies themes from digital content at the location indicated by the input resource identifier and/or digital content in the same domain as the input resource identifier (referred to as “resource identifier content”), and/or the description. A theme can correspond to a label that summarizes the subject, sentiment, concept, or association of a subset of the resource identifier content and/or description. For example, if the resource identifier is to a landing page for an online company specializing in beauty and health care products, themes can be identified labeled as “skincare,” “body & hand,” and “hair.”

A content group includes a set of keywords and a content group resource identifier. A content group can represent a theme at least through its keyword set and content group resource identifier. For example, a content group generated for “skincare” may have keywords such as “anti-aging facial skincare,” “brightening skincare routine,” or “vegan face care.” The system can extract keywords from its input resource identifier and description, as well as generate new keywords that are predicted to relate to the identified theme. A content group resource identifier generated by the system can be the input resource identifier, or a sub-resource identifier. The sub-resource identifier can be, for example, a web page in the site map of a website the input resource identifier is pointing to. For example, an input resource identifier can be “example.com.” The content group generation system can identify a theme for “skincare” with the above-mentioned keywords, and pair that keyword set with a resource identifier “example.com-skincare” to generate a content group.

The system can implement an AI model to determine themes, resource identifiers for resources or sources of digital content related to those themes, and/or keywords related to those themes from the input. As described in more detail, below, the AI model can be trained to classify input digital content against a list of potential labels previously encountered through labeled training data.

The system can also generate digital content items, e.g., in the form of text, images, video, audio, and any combination of the preceding, corresponding to the theme of a content group. Digital content items in a group can be, for example, informative information, entertainment, advertisements, etc. A content group may be referred to as an advertisement group or an ad group, for example, when the digital content items in the group are advertisements. The digital content items may, for example, be retrieved and optionally modified from the resource identifier content and/or the description. In addition, or alternatively, the system can generate digital content items, for example, using an AI model trained to generate digital content items.

Content group generation enables campaigns to be generated and deployed by populating a campaign with automatically suggested content groups, generated based on the input resource identifier and the description. Content groups can be provided through a user interface for confirmation before adding to a campaign. Once populated, a campaign management platform can activate a campaign to provide digital content items in response to content requests. Dividing campaigns into multiple content groups allows for increased granularity in selecting how content is delivered and tracked by the campaign management platform. The campaign management platform can receive input to affect how content corresponding to a particular content group is delivered, including how often the content is delivered, when the content is delivered, to whom the content is delivered to, and so on.

Digital content can be classified or described according to multiple themes, and generating content groups from each theme can result in more content groups than is effective for appropriately leveraging campaign management platform features. Dividing campaigns into many content groups can cause the campaign management platform to be less effective at content delivery and performance tracking. For example, the platform may be limited in scaling content groups as part of a campaign. In this specification, the term “overpopulation” can refer to this scenario in which a number of content groups exceeds or would exceed the technical capacity for a platform to manage the campaign. Technical capacity can be determined, for example, based on operating guidelines, a minimum service-level objective, the likelihood that managing a campaign over a certain content group count will degrade platform performance, or limits imposed on users using the platform to generate and manage campaigns.

Another technical problem in the context of overpopulating campaigns on a platform is in the resulting accuracy of data-driven features offered by the platform. For example, assessing performance of a content group can be done based on tracked information by the platform for how content is received or engaged with once delivered. Content groups that are too granular will have limited tracked information, because the volume of requests is lower as compared to a content group with a broader theme. To that end, platform features for evaluating performance are limited to these types of content groups, as the amount of tracked information received is not statistically significant for drawing any data-driven conclusions. In addition, as the number of content groups increases, so does the complexity of the campaign, for example in the form of overly-differentiated tracking information. This increased complexity makes it harder to manually or automatically interpret campaign performance to determine a course of action to take for the campaign to improve or maintain its effectiveness in reaching target audiences with relevant content.

Request coverage is a measure of the responsiveness of keywords of a content group to requests for content, such as search queries to a search engine or content requests generated when a web page is accessed. Total request coverage is a measure of the request coverage across all keyword sets of a campaign including one or more content groups. Request coverage as described herein may also be referred to as query coverage, for example, when the content requests are provided in the form of search queries for content on a search engine. To rank content groups by request coverage gain, a system can first determine the highest overall request coverage for all generated content groups.

Ranking by request coverage alone, however, presents several problems. Two content groups may have high individual request coverage, but collectively does not improve the total request coverage of a campaign. For example, one content group may be a subset of another content group in terms of request coverage, meaning that the inclusion of both content groups in a campaign does not increase the overall number of content requests that are caught by the campaign when the campaign is activated. Further, using request coverage to filter a list of candidate content groups generated according to identified themes does not prevent substantially overlapping content groups from being selected. The ability for a campaign management platform to deliver digital content and tracking delivery performance granularly is therefore not efficiently used, as selected content groups are effectively treated as a broad and generic group.

To address the problem of overpopulating content groups in campaigns of a campaign management platform, aspects of the disclosure provide for ranking candidate content groups according to request coverage gain and optionally one or more other ranking criteria, such as content strength. Request coverage gain refers to a measure of increased or decreased request coverage of one content group relative to another content group. The request coverage gain is the request coverage of keywords in a content group that do not overlap with keywords other content groups of a campaign.

To determine request coverage, the system can receive a list of keywords appearing in search queries or requests for content monitored by a campaign management platform. The system can determine how many keywords in a content group appear in the keyword list, including keywords that may not lexically match, but are semantically similar to other keywords. For example, an appropriately-trained AI model can receive content group keywords and the keyword list as input and determine how similar the group keywords are to the keywords in the list. In some examples, the system can determine request coverage based on the past performance of other content groups with a similar or matching keyword set, against the same or similar target audience sending content requests. In some examples, the system receives performance information indicating how a content group covers incoming content requests over a trial or experimental period.

Request coverage can be determined based on how many keywords in a content group match or are similar to keywords in the maintained list. For example, if a content group has five keywords, and all five keywords are determined to be within a threshold measure of similarity to keywords on the list, then the request coverage for the content group can be represented as 100%. On the other hand, if none of the keywords in a content group are determined to be within a threshold measure of similarity to any keywords on the list, then the request coverage for the content group can be represented as 0%.

Before identifying the content group with the next-highest request coverage, the system removes keywords of the first-ranked content group from the remaining content groups. By removing overlapping keywords before computing request coverage for the remaining content groups, the system causes the resulting request coverage to represent the gain of adding the next content group to a campaign that already includes the highest-ranked content group. To that end, when the system identifies the content group with the highest request coverage after removing overlapping keywords, the system effectively identifies the content group that will best cause the total request coverage of the resulting campaign to increase. The system can repeat this process until each content group is ranked.

By ranking and providing a subset of content groups for inclusion in a campaign according to request coverage gain, content delivery is differentiated by unique content groups, without overpopulating a campaign management platform. Reducing or eliminating content group overpopulation results in less data or metadata that needs to be maintained for different content groups in a campaign, e.g., because redundant content groups that target the same portions of a target audience are eliminated. Relative request coverage as part of generating the content groups determines which of these content groups are eliminated and can be removed. Campaigns are therefore represented in less data, for example because of fewer content groups overall.

Representing campaigns with less data can directly improve the overall performance of the platform. For example, campaigns represented in less data can be accessed for responsiveness to incoming content requests faster, as less data is read overall. Given that campaign management platforms track data on campaign performance, data-driven features offered by the platform, e.g., tracking and analyzing user engagement metrics for served content, conversion, interaction, and/or engagement with served digital content, and so on, can be performed more accurately and efficiently with fewer, more granular, content groups. These data-driven features can be performed more accurately at least because the data is neither too general so as to not provide any specific insight of segments of audiences targeted by the content group, nor too narrow so as to prevent enough data to be gathered for generating statistically-significant data-driven conclusions. The results of analyzing present performance and predicting future performance of a content group is improved using these tracked metrics can be generated faster, e.g., in less wall-clock time, and more campaigns can be analyzed overall. The results of these features can be used to inform future campaign design and strategies, which can further improve the performance of the platform in serving digital content to responsive audiences.

The content groups are unique in that their overlapping request coverage is reduced, as compared to campaign management approaches that rely on absolute request coverage for ranking. The performance of the campaign management platform in serving digital content during a campaign flight is improved, at least because the differentiated content groups allow for selecting content groups under any technical capacity limits of the campaign management platform. At the same time, finite content group slots in a campaign are not wasted on overlapping groups that do not improve the campaign's performance toward maximizing coverage of digital content requests from a target audience.

Balancing the number of content groups in a given campaign as described herein can also reduce data storage requirements by the campaign management platform. This is at least because fewer content groups and their corresponding digital content items need to be stored, versus approaches in which more content groups are added that still may not contribute to a higher total request coverage.

Beginning with more candidate content groups than what is selected in a campaign reduces potential gaps in coverage of a campaign with groups selected from the candidates. However, to reduce or mitigate performance degradation from too many content groups being included in a campaign, the candidates are selected at least according to request coverage gain, to improve total request coverage without adding content groups that are redundant in coverage to a campaign. Redundant coverage also increases storage requirements by the platform implementing the campaign. The content groups that are selected for the campaign represent meaningful segments of the types of digital content that are requested, for example because a system identifies specific types of products or services that may be offered based on an input resource identifier and a description. The selected content groups can also have a lower storage requirement, overall, at least because content groups that do not contribute to a higher total request coverage are omitted.

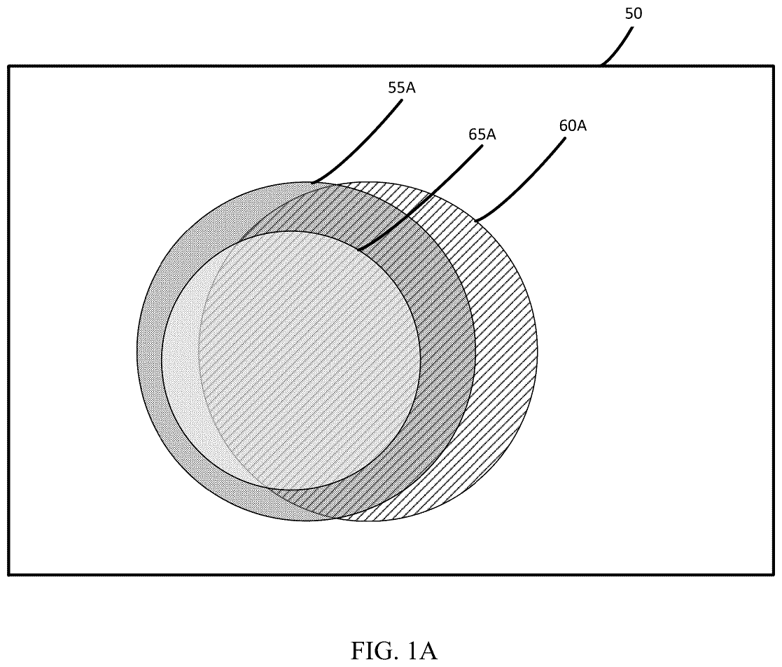

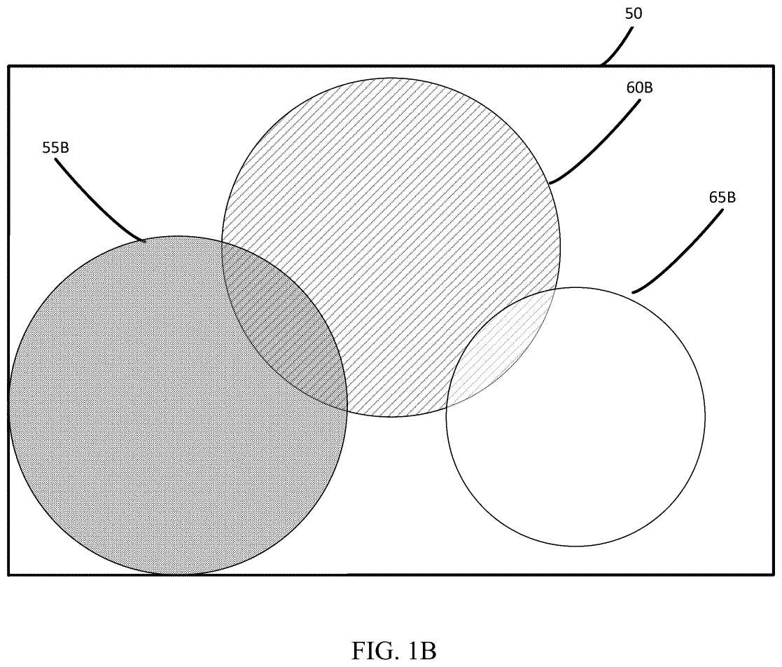

FIG. 1A is an example illustration depicting total request coverage by a campaign of content groups generated without ranking by request coverage gain. Box 50 represents all possible content requests. Circles 55A, 60A, and 65A represent the request coverage corresponding to the three content groups, respectively. The total request coverage of the three campaigns is represented by the area of the circles 55A, 60A, and 65A. In the example illustrations of FIGS. 1A and 1B, more physical area covered by a circle in the box corresponds to a higher measure of request coverage by a corresponding content group against all possible content requests. As shown in FIG. 1A, circle 65A is wholly within the area covered by circle 55A, corresponding to a content group that is a subset of another content group in terms of request coverage.

As compared with the illustration in FIG. 1B, the circles 55A, 60A, and 65A in FIG. 1A overlaps more than the circles 55B, 60B, and 65B in FIG. 1B. While the sizes of the circles representing individual request coverage is the same in both figures, FIG. 1A illustrates how not accounting for request coverage gain can result in content groups that, overall, cover fewer content requests. The circles 55A, 60A, and 65A may correspond to thematically similar content groups, such that selecting these content groups based on just request coverage may not increase total request coverage of the campaign.

FIG. 1B is an example illustration depicting total request coverage by a campaign of content groups generated with ranking by request coverage gain, according to aspects of the disclosure. Box 50 again represents all possible content requests, but circles 55B, 60B, and 65B correspond to content groups that were ranked and selected for inclusion in a campaign based on request coverage gain. For purposes of explanation, the content groups corresponding to circles 55B, 60B, and 65B individually have the same request coverage as their counterpart groups corresponding to circles 55A, 60A, and 65A. However, the content groups selected according to request coverage gain have higher total request coverage for their shared campaign, as indicated by less overlap in the circles 55B, 60B, and 65B in FIG. 1B relative to the circles 55A, 60A, and 65A in FIG. 1A. Therefore, request coverage gain as a ranking criterion enables content groups to be selected to differentiate between one another to improve overall request coverage, while still being used as a filter to prevent overpopulation of content groups by theme to a campaign.

Other ranking criteria can also be used for content group selection. Ranking criteria can refer to criteria for comparing content groups for ranking, as well as criteria which, when not met, causes the content group generation system to remove the content group from the ranking altogether. Ranking criteria can be determined, for example, using an appropriately trained AI model trained or fine-tuned on different examples of content groups meeting or not meeting various ranking criteria.

The ranking criteria can be applied by the content group generation system as additional filters to content groups ranked according to request coverage gain. In some examples, multiple ranking criteria are factored together during ranking by the system, with different associated weights to increase (or decrease) the impact of any particular criterion on the overall ranking. These weights may be adjusted automatically by an AI model or predetermined. Example other ranking criteria described herein include content strength, theme importance, and theme to resource identifier relevance. In addition, or alternatively, the content group generation system can filter our content groups generated with invalid or broken resource identifiers. Applying additional criteria can further address the problem of “overpopulating” a campaign as described herein, at least in that only the highest ranked content groups are selected for occupying limited space in a given campaign.

Selecting content groups based on request coverage gain can improve the operation of content delivery platforms configured to serve content to audiences of users, at least because content groups can be selected to increase overall total audience coverage, improving the performance of the platform directly through increased outreach for the same amount of digital content sent to user computing devices. Redundant or overlapping content groups in a managed campaign can also be reduced, and selecting by request coverage gain can improve data-driven features of a content delivery platform, for example by reducing the chance of including content groups that reach few or no additional audience members as compared with other content groups in the campaign. In addition to potentially not improving the overall coverage of the campaign, overly-granular content groups may target too small an audience for the platform to receive statistically significant information for evaluating the group's performance relative to the target audience as a whole.

Further, generating content groups of keywords and digital content based on relevance or request coverage alone does not account for the potential overlap in audience targeting the generated groups have. By selecting the generated content groups based on the ranking of request coverage gain, content delivery is differentiated by unique content groups, where the differentiation is directly related to how much of an audience a campaign may reach based on the gain from any one content group. The platform serving and managing the campaign can reduce data storage requirements for a campaign by limiting the content groups to those selected at least by request coverage gain. The selection also allows for a quantity of content groups to be provided below an explicit or implicit technical capacity of the platform to serve any one campaign, which can improve the overall performance of the content delivery platform over approaches in which campaigns are filled with overlapping content groups.

### Example Systems

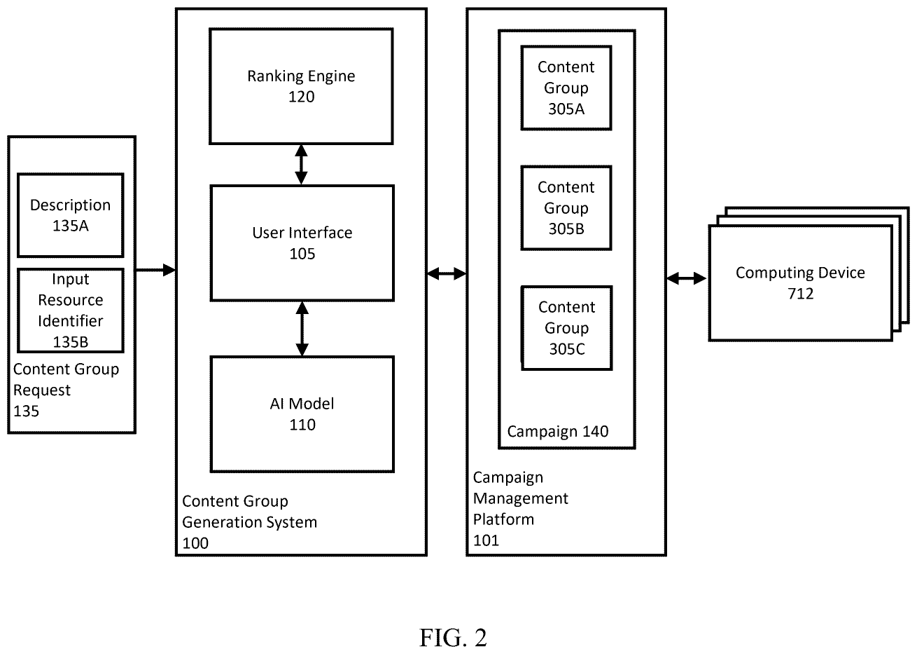

FIG. 2 is a block diagram of an example content group generation system 100, according to aspects of the disclosure. The content group generation system 100 includes a ranking engine 120, a user interface 105, and an AI model 110. The content group generation system 100 receives content group requests 135, generates content groups, ranks the content groups, and provides the ranked content groups to the campaign management platform 101 for serving digital content and tracking performance of a corresponding campaign.

Content group request 135 includes a description 135A and an input resource identifier 135B. The description 135A can be, for example, a text explanation or description of digital content to be served, an owner or author of the digital content, suggested themes and details to emphasize in digital content served to a target audience. The input resource identifier 135B identifies a source or location of digital content. For example, the resource identifier 135B can be a URL to a landing page that is to be served with digital content items during a campaign. The input resource identifier 135B can identify any source of digital content, for example through a web page, a mobile application, a file server, and so on. The input resource identifier 135B may be part of a hierarchy or collection of resource identifiers, for example a home page of a website such as example.com, with several resource identifiers to other pages on the website, such as example.com-skincare, example.com-hair, and so on.

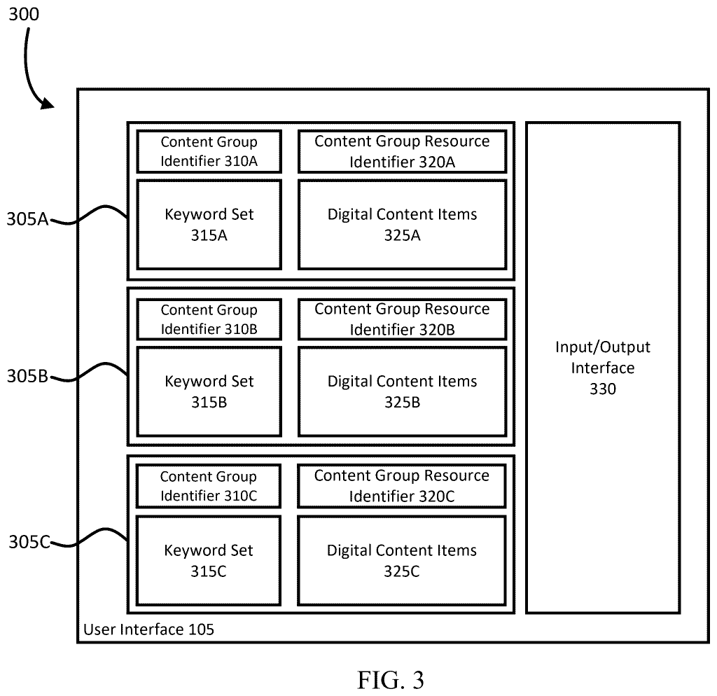

The content group request 135 can be received by the content group generation system 100 from a computing device, such as a computing device for a user of the campaign management platform 101 generating or modifying a campaign. As described herein, for example, with reference to FIG. 3, the user interface 105 can cause content groups to be displayed or output on a user computing device prior to inserting the groups into a campaign. The user interface 105 can receive input to modify, add, or delete content groups, either partially or in their entirety. The user interface 105 can receive input to confirm the content groups and add them to a designated campaign. The content group generation system 100 can save pending changes to the campaign prior to confirming the changes. An AI model, e.g., AI model 110, can be trained to generate these content groups and can be fine-tuned with feedback provided in the form of changes to the content groups by user input.

The content group generation system 100 can be implemented as part of or in communication with a campaign management platform 101. In some examples, the content group generation system 100 and the campaign management platform 101 are implemented on different computing devices in different physical locations. A campaign management platform 101 can be configured to receive digital content requests, for example from computing devices such as computing device 712. Digital content requests can be provided through various formats, for example as queries to a search engine, or automatic requests sent to the campaign management platform for populating parts of a web resource, such as a web page or mobile application, with content. In some examples, the user interface may be a web page, a standalone desktop application, one or more APIs exposing the validation system to the user computing device, or any other mechanism for communicating data between devices.

Digital content requests can come in different forms. For example, a digital content request may come directly as user input to a search engine or other system for retrieving digital content responsive to the queries. As another example, a computing device loading a web page or application may automatically generate one or more digital content requests for populating parts of a user interface corresponding to the page or application.

The campaign management platform 101 is configured to manage various campaigns, such as campaign 140. Digital content delivery by the campaign management platform 101 may be organized as one or more campaigns, each campaign logically associated with some subject content. Campaigns may be further subdivided into content groups, representing potential variations on the type of content to be served. Groups may be further subdivided into line items, representing even more specificity in the digital content to be served, the time at which to serve the content, and/or the computing devices that are a target of the digital content. The time at which to serve the digital content can be referred to as a flight for the content. Digital content, the period of time at which the digital content is to be served to different user computing devices, and/or targeting parameters for selecting which user computing devices to serve the content to may be selected at either the campaign, group, or line-item level.

For example, the relevant content requests can be limited to a target audience defined by the campaign 140 that will include the generated content groups 305A-305C. Content groups or a campaign in general can specify targeting parameter values for a target audience for serving content to when a campaign is activated. The targeting parameter values can be based on demographics of members of the audience, characteristics of the computing devices used to request digital content, the locations of the computing devices used to request digital content, and so on.

The campaign management platform 101 can onboard new users or interact with existing users. New users may have no or limited experience with generating campaigns that perform well, according to criteria such as click-through rate (CTR), conversions, target audience outreach, and so on. Even for existing users, the content generation system 100 facilitates the creation of content groups in a campaign that identifies keywords and digital content items for identifying and responding to relevant content requests.

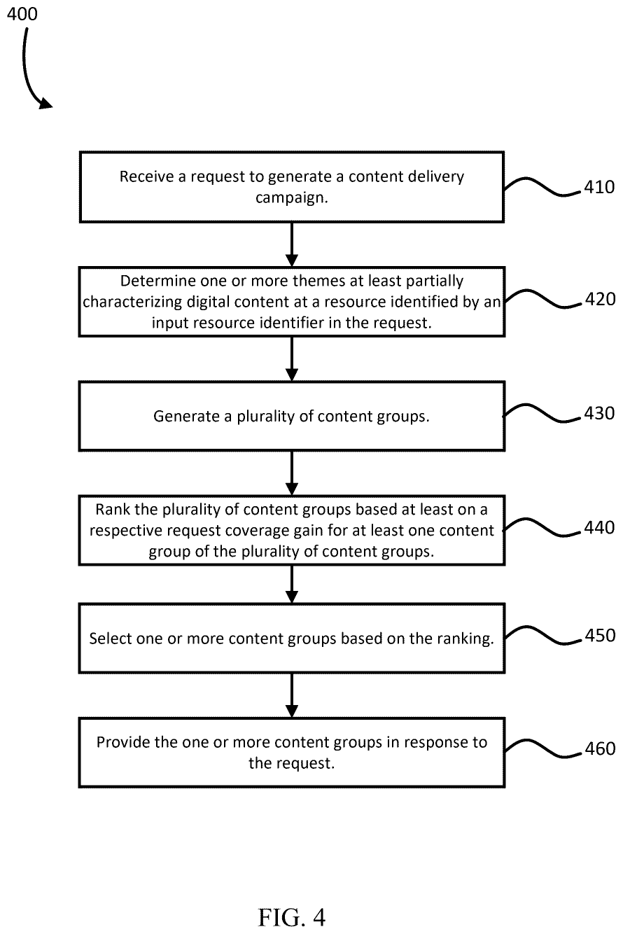

As described herein with reference to FIG. 4, the content group generation system 100 is configured to receive the content group request 135 and identifies one or more themes corresponding to digital content at a location identified by the input resource identifier 135B and the description 135A. Various operations performed by the content group generation system 100 can be executed using one or more AI models, such as the AI model 110. The AI model 110 can be trained to process multi-modal input, e.g., text, video, images, audio, etc., and identify one or more themes describing or classifying the input. The AI model 110 can receive digital content at the location indicated by the input resource identifier 135B, as well as any additional input provided, such as, for example, the description 135A.

The AI model 110 can be, for example, a multi-modal generative model trained on labeled examples of input of different themes. The AI model 110 can be trained to generate an encoded representation of the input, e.g., one or more embeddings, and identify other embeddings corresponding to different themes. The AI model 110 can access an embedding repository (not shown) for querying embeddings that have been previously generated. The AI model 110 can also query associated labels for stored embeddings, and/or identify a learned theme for embeddings of different values or locations in an embedding space.

After identifying the themes, the AI model 110 or a different AI model can be trained to generate content groups corresponding to those themes. For example, if an identified theme is “skincare,” the AI model 110 can generate a set of keywords corresponding to skincare, a name for a content group, e.g., “skincare,” and a resource identifier corresponding to the identified theme. The resource identifier can be the resource identifier 135B, or a resource identifier accessible from the resource identifier 135B. For example, the system 100 can crawl through a sitemap corresponding to the resource identifier 135B, to identify different resource identifiers that are accessible from the resource identifier 135B.

The output of the AI model 110 can be pairs including themes and content group resource identifiers. The themes are represented by keywords corresponding to the theme, while the content group resource identifier is a prediction of the AI model 110 of a resource identifier that points or leads to digital content that is most similar to the identified theme. The system 100 can generate, from the pairs, content groups including keyword sets and content group resource identifiers.

Content groups may have additional information, such as a name, and digital content items, that are not in the output from the AI model 110. As part of generating the content group, the AI model 110 or another model can be trained to generate digital content corresponding to keywords representing a theme. The AI model 110 can receive, as input, keywords and resource identifiers point to digital content, and generate digital content items that are similar to the keywords and existing digital content. The AI model 110 can implement a generative model such as a diffusion model for generating images or other digital content from a prompt including keywords and digital content at a location pointed to by an input resource identifier. Other additional information can include performance metrics, e.g., corresponding to measurements taken by the platform 101 related to user engagement, conversion, or other types of user interactions with served digital content.

The AI model 110 can be a pre-trained generative model, e.g., pre-trained to generate keywords, video, audio, and so on, fine-tuned with examples of content groups of themes and digital content items. For example, the AI model 110 can receive examples of descriptions and digital content, such as what may be received by the system 100. The examples can be annotated with a corresponding content group representing a theme identified from the description and/or the digital content at the location indicated by an input resource identifier. The AI model 110 can generate a predicted content group based on the input, and a difference can be computed between the prediction and the annotated content group. The difference can be treated as a loss used to backpropagate through the model 110 to update its model parameter values, such as weights or biases.

In some examples, the input resource identifier 135B may not point to a location with much digital content, e.g., text only, or only one or two images or videos. In those cases, the AI model 110 can additionally receive the description 135A as input, which can be used as part of a prompt that may include natural language and for generating digital content items corresponding to a received keyword set. After generating the digital content items, the content group generation system 100 can add the digital content items to the content groups populated using the model-generated keyword set and input resource identifier pairs.

The AI model 110 can generate multiple candidate content groups, from which groups are selected by the system for inclusion in a campaign. Beginning with more candidate content groups than what is selected in a campaign reduces potential audience gaps in coverage of a campaign with groups selected from the candidates. An audience gap can be a gap in which a campaign is generated with content groups, with at least some part of the target audience for the campaign is not served digital content. The AI model 110 can generate many different content groups automatically and which will be related thematically to digital content indicated by the input resource identifier.

Content groups that are thematically related to an input description and/or content at a location indicated by a resource identifier, alone, however, do not account for performance degradation from too many content groups being included in a campaign. A campaign may be considered to have too many content groups, for example, when the number of content groups is in excess of a technical capacity limit. The limit can be a hard limit imposed by the campaign management platform, to reduce computing resource overutilization from users of one campaign relative to other campaigns over other users for which content is also being served to respective target audiences. In some examples, a limit may not be a hard limit, but one that is associated with performance degradation, e.g., because computing resources such as memory bandwidth, processing cycles, and/or memory allocated for running a campaign on the platform is insufficient for meeting certain performance thresholds or minimums.

As described herein, the platform 101 selects from candidate content groups at least according to request coverage gain, to improve total request coverage without adding content groups that are redundant in coverage to a campaign. This is at least because content groups can be selected under a technical capacity limit, reducing or eliminating performance degradation caused by limited resources of the platform executing a given campaign that is over the limit. Redundant coverage also increases storage requirements by the platform implementing the campaign. The content groups that are selected for the campaign represent meaningful segments of the types of digital content that are requested, for example because a system identifies specific types of products or services that may be offered based on an input resource identifier and a description. The selected content groups can also have a lower storage requirement, overall, at least because content groups that do not contribute to a higher total request coverage are omitted.

After the content groups are generated, the ranking engine 120 ranks the groups. As described herein, by ranking according to request coverage gain, the ranking engine 120 can identify a list of content groups, which, when added to a campaign, improves the total request coverage overall. Improving the total request coverage overall results in content groups having minimal overlap, as compared to previous campaign management approaches in which request coverage alone is used. To that end, the content group generation system 100 can meet the finite cap of content groups that a campaign can include without degrading the performance of the content serving or performance tracking by the campaign management platform. Storage requirements are also reduced, because fewer content groups can be added to a campaign for higher total request coverage.

The content groups that are selected are differentiated from each other, at least in that each content group covers distinct subsets of content requests that can come in from the computing devices, e.g., computing device 712. The platform 101 can therefore operate within its technical limitations for serving and tracking campaigns. Users of the campaign management platform 101 generating the content groups using the content group generation system 100 are able to do so without manually identifying content groups, which may end up largely overlapping and collapsing into an undifferentiated campaign.

The system 100 is configured to generate request coverage for various content groups, for example, based on matching or similar keywords between a content group and a list of keywords from received content requests. For example, the campaign management platform 101 can receive content requests and maintain a keyword list of keywords appearing in the content requests. The content requests used to determine the keyword list may include some or all of the requests, requests from a target audience, determined by one or more targeting parameters. The target audience can correspond to a target audience indicated in a campaign for which the content group may be added to.

The system 100 can implement one or more AI models or other approaches to determine matching or similarities between keywords in a content group and a maintained keyword list from content requests. Matching can be lexical, semantic, and so on. For example, keywords may be matched for sharing the same lexical stem or root, or if they are synonyms of one another, or if some words are specific instances of more general concepts, for example “sneaker” and “shoe.” In some examples, the system 100 can determine the similarity of words within a threshold value of similarity relative to one another, for example based on a distance in between embeddings in an embedding space populated by encoded representations of various different keywords. Negative cosine similarity may be one metric used to determine similarity, and a threshold may be predetermined with different values from example-to-example.

Request coverage can be represented, for example, based on how many keywords in a content group match or are similar to keywords in the maintained list. For example, if a content group has five keywords, and all five keywords are determined to be within a threshold measure of similarity to keywords on the list, then the request coverage for the content group can be represented as 100%. On the other hand, if none of the keywords in a content group are determined to be within a threshold measure of similarity to any keywords on the list, then the request coverage for the content group can be represented as 0%.

In some examples, request coverage can be based on past performance of other content groups with a similar or matching keyword set, against the same or similar target audience sending content requests. In some examples, the system 100 receives performance information indicating how a content group covers incoming content requests over a trial period.

The ranking engine 120 can rank content groups generated by the content group generation system 100 according to other ranking criteria. One example ranking criterion is theme importance. Theme importance can measure the relevance of a theme corresponding to a content group with one or more themes identified in the digital content located at the resource corresponding to the input resource identifier 135B. For example, some resource identifiers may point to website pages or other digital content that is tangential to the themes identified in the input resource identifier 135B. The input resource identifier 135B is considered a representation of the types of digital content that is to be served, and therefore some content groups may be ranked lower for not corresponding to the identified important themes. Theme importance can also be based on predicted relevance of different themes to digital content requests, e.g., whether keywords in digital content requests match or are similar to keywords representing a particular theme. Some themes identified may be predetermined to be important or not important, for example based on excluding or including certain types of predetermined subject matter present in different identified themes.

To determine theme relevance, the content group generation system 100 can use an AI model, such as the AI model 110, to determine which themes are more relevant, and therefore more important, to content at a location indicated by the input resource identifier 135B. The AI model 110 can be trained, for example, to cluster digital content corresponding to each identified theme and determine the largest cluster. In other examples, theme importance can be determined based on how often a theme is mentioned or referred to in the digital content. In some examples, a combination of approaches is applied by the AI model 110 to determine theme importance.

Another example criterion is theme to resource identifier relevance. Theme to resource identifier relevance measures the relevance of a theme of a content group with digital content located at a resource corresponding to a resource identifier for the content group. Digital content at a given resource indicated by a resource identifier may be more or less relevant based on, for example, a model determination of how often a theme is mentioned or referenced in the digital content. As described herein, in some examples, the AI model 110 can cluster digital content based on digital content that is related to a paired theme with the input resource identifier, versus digital content that is not related. The extent of this clustering can be a metric by which content groups are ranked, to prioritize content groups with more strongly-tied relationships between theme and digital content at a corresponding resource location.

An example ranking criterion is content strength. Content strength measures the adherence of digital content in a content group with one or more predetermined content guidelines. Content groups whose digital content is ranked according to content strength may receive indicators such as “excellent,” “great,” “poor” or other descriptive indicators of content strength relative to the content guidelines. The content guidelines may be specific to the digital content provider, the campaign management platform, or relate to general practice or suggested guidelines for presenting digital content. Example content guidelines can include a minimum level of detail, a resolution size minimum for image or video components, unique headlines or other text content, and any other characteristic that has been associated with improved reception of digital content by served users. Other ranking criteria that may be used include click-through rate (CTR), conversion rate (CVR), query volume.

After ranking the content groups, the content group generation system 100 can select the top-ranked content groups. The number of groups can be based on, for example, the number of recommended or allowed content groups in a campaign served or tracked by the campaign management platform 101. Before finalizing the content groups, the content group generation system 100 can output the content groups through the user interface 105. The content groups after finalization can be the content groups 305A, 305B, and 305C.

FIG. 3 is an example view 300 of the user interface 105 for providing candidate content groups for user confirmation, according to aspects of the disclosure. The user interface 105 can include input/output components that can be displayed or otherwise output through a user computing device. The example view 300 shows content groups 305A, 305B, 305C, and input/output interface 330.

Each content group is shown with fields, including a content group identifier, a content group resource identifier, a keyword set, and digital content items. For example, the content group 305A includes content group identifier 310A, content group resource identifier 320A, keyword set 315A, and digital content items 325A. The content group 305B includes content group identifier 310B, content group resource identifier 320B, keyword set 315B, and digital content items 325B. The content group 305C includes content group identifier 310C, content group resource identifier 320C, keyword set 315C, and digital content items 325C.

Content group identifiers can be generated by the AI model 110 as part of generating the content groups. A content group identifier may identify the theme or themes associated with the corresponding content group. For example, content group identifiers 310A, 310B, and 310C can be “skincare,” “body & hand,” and “hair,” respectively.

Keyword sets display or output keywords generated as part of the content groups. The campaign management platform 101 can use the keyword sets to determine content groups that are responsive requests for content, for example, because the request includes the same or similar keywords within a similarity threshold. For example, keyword set 315A for content group 305A can include keywords such as “anti-aging facial skincare,” “brightening skincare routine,” or “vegan face care.”

The view 300 also shows resource identifiers 320A, 320B, and 320C. The resource identifiers may be uniform resource identifiers (URIs) or uniform resource locators (URLs). A resource identifier can include the input resource identifier 135B as shown in FIG. 2, or a resource identifier to a resource accessible through the input resource identifier 135B. The AI model 110 is trained to identify a resource identifier corresponding to the theme for a content group, e.g., based on predicted similarity between digital content at the resource indicated by the resource identifier and a theme identified from the input resource identifier.

Digital content items 325A, 325B, 325C are digital content items, such as text, image, video, audio, or combinations of the preceding. As described herein with reference to FIG. 2, the AI model 110 may be trained to generate digital content items, for example, based on digital content at a resource indicated by the input resource identifier 135B, keywords in a keyword set, or other input. The additional input can be provided through the input/output interface 330.

Input/output interface 330 is configured to allow for input and output, e.g., as text, audio, images, video, and so on. For example, the input/output interface 330 can be a dialogue box between a user computing device and a chat-bot agent. The chat-bot agent can communicate input and output to one or more AI models, such as AI model 110 of FIG. 2. Input can be provided through the chat interface. Responses can be sent back by the system in the form of a continuing chat dialogue with a chat-bot agent. The input/output interface 330 can receive the content group request 135 and/or cause content groups to be displayed or output to the user interface 105 for editing the content groups, confirming the content groups for inclusion in a campaign. In various examples, the input/output interface 330 can also facilitate user interaction with the campaign management platform 101 for managing, activating, or tracking campaigns.

In various examples, content groups can be displayed or output with more or fewer fields. Additional fields include targeting parameter values for specifying a target audience for the content group, information related to flights of the content group, and/or values or weights affecting the probability a particular digital content item in a content group is served in response to a request. Further, view 300 is an example view of the user interface 105, which in various examples can be used to handle input and output for performing other operations related to campaign management. These operations can be, for example, managing, editing, adding, removing, or activating campaigns, tracking information related to campaign performance, or enabling various features or optimizations the campaign management platform 101 is configured to perform. These features or optimizations can affect how campaigns are generated, managed, activated, or tracked by the campaign management platform 101.

The user interface 105 can include a number of user-interactable elements, e.g., buttons, editable fields, upload tools, sliders, and so on, for editing any part of a content group. The user interface 105 can further include a user-interactable element for receiving input to confirm the selection and state of content groups for adding to a new or pre-existing campaign.

### Example Methods

FIG. 4 is a flow diagram of an example process for generating content groups for a campaign, according to aspects of the disclosure. The example process can be performed on a system of one or more processors in one or more locations, such as the content group generation system 100 of FIG. 1. The following operations of the example processes described herein, e.g., processes 400 and 500, do not have to be performed in the precise order described below. Rather, various operations can be handled in a different order or simultaneously, and operations may be added or omitted.

The system receives a request to generate a content delivery campaign, according to block 410. The request can be, for example, content group request 135 as shown and described with reference to FIG. 2. The request can be to generate a content delivery campaign generally, of which one or more content groups generated in accordance with the process 400 are also generated. In some examples, the request received is one specifically for generating content groups, for example, for adding to a pre-existing campaign.

The request can include an input resource identifier identifying a location for a resource of digital content, such as a landing page of a website. The request may include a description of the digital content at the resource, for example the description 135A and resource identifier 135B as shown and described with reference to FIG. 2. In some examples, only a resource identifier is provided without an accompanying description.

The system determines one or more themes at least partially characterizing digital content at a resource identified by an input resource identifier in the request, according to block 410. The system can implement an AI model, such as AI model 110 as shown and described with reference to FIG. 2, that is trained to identify themes corresponding to at least the digital content at a resource identified by the resource identifier. The AI model 110 can be one of one or more AI models trained to perform various AI tasks described herein, such as theme identification, digital content item generation, and keyword set generation for generating content groups.

The system generates a plurality of content groups, according to block 430. A content group includes a keyword set and a resource identifier, such as keyword sets 305A-305C and resource identifiers 320A-320C of content groups 305A-305C as shown and described with reference to FIG. 3. The system can generate one or more content groups for each determined theme, generating a list of candidate groups for ranking and filtering before finalizing the campaign.

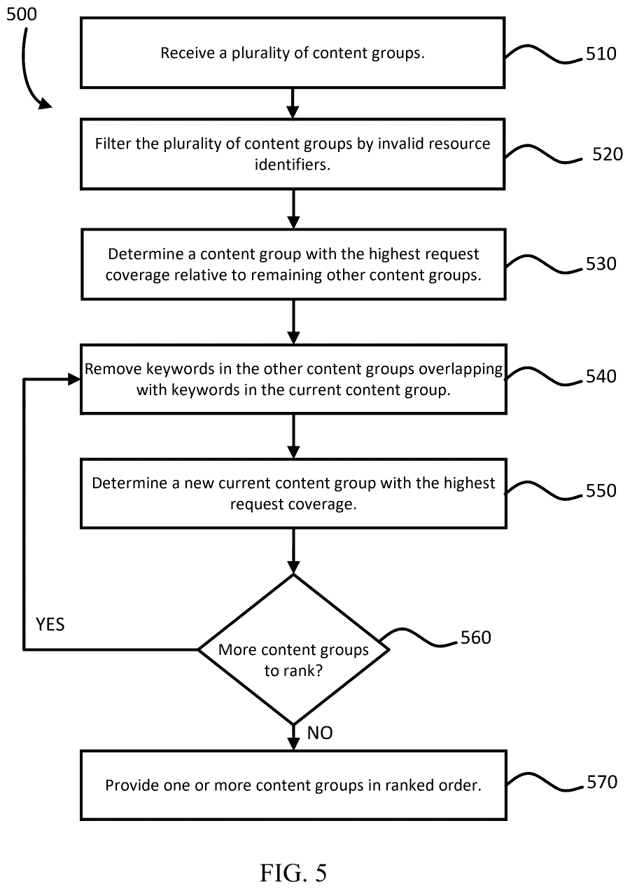

The system ranks the plurality of content groups based at least on a respective request coverage gain for at least one content group of the plurality of content groups, according to block 440. In some examples, other ranking criteria can be used in addition to the request coverage gain to rank the content groups. These ranking criteria can be applied as a separate process, e.g., the process 500, or part of the process 400. The process 500 as described and shown with reference to FIG. 5 is an example process for determining request coverage gain.

For example, the system can rank content groups according to theme relevance, content strength, and/or theme to resource identifier relevance. In some examples, the system can determine a theme to resource identifier relevance for a content group falls below a predetermined relevance threshold; and in response to determining that a theme to resource identifier relevance for a content group falls below a predetermined relevance threshold, e.g., a percentage value or confidence value output by a model. The system can delete, by the one or more processors, the content group, or replace a resource identifier for the content group with the input resource identifier.

The system selects one or more content groups based on the ranking, according to block 450. The number of content groups selected can be, for example, by user input, or predetermined based on suggested or technical capacity limits on the number of content groups to include in a campaign.

The system provides the one or more content groups in response to the request, according to block 460. The content groups can be provided to a user interface for editing or finalization, or, in some examples, automatically added directly to a campaign.

FIG. 5 is a flow diagram of an example process 500 for ranking content groups according to request coverage gain, according to aspects of the disclosure. A ranking engine of a content group generation system, e.g., the ranking engine 120 of the content group generation system 100 of FIG. 2, can perform the process 500.

The system receives a plurality of content groups, according to block 510. The content groups received can be generated by an AI model, for example, the AI model 110 of FIG. 2 while the system 100 performs the process 400 of FIG. 4.

The system filters the plurality of content groups by invalid resource identifiers, according to block 520. Invalid resource identifiers can include broken or invalid URLs that do not point to a web page or other source of digital content.

The system determines a content group with the highest request coverage relative to remaining other content groups, according to block 530. As described herein with reference to FIG. 2, the system can determine request coverage, for example, based on matching or similar keywords between a content group and a list of keywords from received content requests. For example, the campaign management platform can receive content requests and maintain a keyword list of keywords appearing in the content requests. The content requests or search queries used to determine the keyword list may include some or all of the requests, and/or requests from a target audience determined by one or more targeting parameters. The target audience can correspond to a target audience indicated in a campaign for which the content group may be added to.

In some examples, request coverage can be based on past performance of other content groups with a similar or matching keyword set, against the same or similar target audience sending content requests. In some examples, the system receives performance information indicating how a content group covers incoming content requests over a trial period.

The system removes keywords in the other content groups that overlap with keywords in the current content group, according to block 540. More specifically, keywords in the current content group are removed from the list of keywords in other content groups. By removing the keywords found in the content group with the highest request coverage from the other content groups, the remaining keywords represent the differences in the remaining content groups. The request coverage of those remaining content groups will represent the gain of total request coverage in adding those content groups to a campaign already including the content group with the highest request coverage.

For example, content group A is determined by the system to have the highest request coverage out of a collection of content groups A, B, C. For purposes of this example, content group A has a keyword set with keywords X, Y, Z, content group B has keywords X, A, E and content group C has keywords Y, E, F. After removing from content groups B and C the keywords in content group A that overlap with keywords in content groups B and C, content group B is updated to include the keywords A, E and content group C is updated to include the keywords E, F. Overlapping keywords are temporarily removed for purposes of determining request coverage gain, but changes to the content groups are reverted prior to outputting the content groups in ranked order, according to block 570.

The system determines a content group with the highest request coverage from the updated content groups, according to block 550. The system can determine request coverage as described herein with reference to block 530, but using the updated content groups after the overlapping keywords are removed. The content group determined at this step is ranked below the previously determined content group.

Returning the example of content groups A, B, C, content group B has keywords A, E and content group C has keywords E, F. Assume for purposes of this example that the system determines content group B to have the highest request coverage, according to block 550. The system removes keywords from content group B overlapping with the remaining keywords in content group C. Content group C is updated to have keyword F. For this example, content group C is the last remaining content group and so would be ranked last by request coverage gain, but the process 500 can loop through one or more iterations until each content group is ranked.

The system determines whether there are more content groups to rank, according to block 560. If there are more content groups to rank (“YES”), then the system removes keywords and determines a new current content group, repeating blocks 540, 550, and 560, until there are no more content groups to rank. If the system determines that there are no more content groups to rank (“NO”), then the system provides one or more content groups in ranked order, according to block 570. For example, the one or more content groups can be provided as output to the system ranking the content groups, e.g., as in block 440 of the process 400.

Another example includes content groups C₁ . . . Cₙ with corresponding keyword sets K₁ . . . Kₙ, where Kᵢ is the keyword set in content group Cᵢ, 1≤i≤n. Let R(⋅) represent the request coverage function measuring the request coverage of a keyword set Kᵢ. Starting with the highest request coverage, let R(K₁)=MAX(R(K₁), . . . , R(Kₙ)). Then content group C₁ with K₁ has the highest request coverage out of the sets.

To determine the next highest request coverage, the ranking engine can compute MAX(R(K₂−K₁), R(K₃−K₁), . . . R(Kₙ−K₁)). The “−” operator represents a set subtraction operation, in which keywords from the set K₁ are removed from keyword sets K₂ . . . Kₙ. For ease of explanation, assume R(K₂)=MAX(R(K₂−K₁), R(K₃−K₁), . . . R(Kₙ−K₁)). Content group C₂ with K₂ has the second highest request coverage gain after K₁.

To determine the third-highest request coverage, the ranking engine can compute R(K₃)=MAX(R(K₂−(K₁∪K₂)), R(K₃−(K₁∪K₂)), . . . R(Kₙ−(K₁∪K₂))). The “∪” operator represents a set union operation, in which keywords from K₁ and K₂ are combined to a set (K₁∪K₂). For the i-th highest request coverage, the ranking engine can compute R(Kᵢ₎=MAX(R(Kᵢ₋₁−Kᵣ), R(Kᵢ−Kᵣ), . . . R(Kₙ−Kᵣ)), where Kᵣ=(K₁∪K₂ . . . ∪Kᵢ₋₁). The ranking engine can compute request coverages for each remaining content group until ranking the last group Cₙ.

Implementations of the present technology can each include, but are not limited to, the following. The features may be alone or in combination with one or more other features described herein. In some examples, the following features are included in combination:
(1) A method for content group generation for a digital content delivery campaign, including: receiving, by one or more processors, a request to generate a content delivery campaign, the request including an input resource identifier; determining, by the one or more processors, one or more themes at least partially characterizing digital content at a resource identified by the input resource identifier; generating, by the one or more processors, a plurality of content groups, each content group including a respective set of keywords and a respective resource identifier corresponding to a respective theme; ranking, by the one or more processors, the plurality of content groups based at least on a respective request coverage gain for at least one content group of the plurality of content groups relative to other content groups in the plurality of content groups; selecting, by the one or more processors and based at least on the ranking, one or more content groups of the plurality of the content groups; and in response to the request, providing, by the one or more processors, the one or more content groups.
(2) The method of (1), wherein the request coverage gain is the request coverage of keywords in a content group that do not overlap with keywords in other content groups of the plurality of content groups.
(3) The method of either (1) or (2), wherein ranking the plurality of content groups includes: determining a first content group with the highest request coverage gain relative to other content groups of the plurality of content groups; removing overlapping keywords from the other content groups, wherein overlapping keywords are one or more keywords that are in both the first content group and the other content groups; and determining a second content group with the next highest request coverage from the other content groups with overlapping keywords removed.
(4) The method of (3), further including performing one or more iterations of: determining, by the one or more processors, a respective next content group from the other content groups with the highest request coverage gain; and removing, by the one or more processors, keywords from the other content groups that overlap with keywords from the respective next content group.
(5) The method of any one of (1) through (4), wherein generating the plurality of content groups includes: determining, by the one or more processors, that a content group of the plurality of content groups includes a respective resource identifier that is invalid; and either: removing, by the one or more processors, the content group with the respective resource identifier that is invalid, from the plurality of content groups; or replacing, by the one or more processors, the respective resource identifier with the input resource identifier.
(6) The method of any one of (1) through (5), wherein: the request further includes an input description corresponding to the digital content at the resource identified by the input resource identifier; and determining the one or more themes further includes determining the one or more themes based at least on the digital content at the resource identified by the input resource identifier and the input description.
(7) The method of any one of (1) through (6), wherein ranking the plurality of content groups further includes ranking in accordance with one or more of: a content strength value measuring the adherence of digital content in a content group with one or more predetermined content guidelines, a theme importance value measuring the relevance of a theme corresponding to a content group with one or more themes identified in the digital content located at the resource corresponding to the resource identifier, or a theme to resource identifier relevance value measuring the relevance of a theme of a content group with digital content located at a resource corresponding to a resource identifier for the content group.
(8) The method of (7), wherein ranking the plurality of content groups further includes: determining, by the one or more processors, that a theme to resource identifier relevance for a content group falls below a predetermined relevance threshold; and in response to determining that a theme to resource identifier relevance for a content group falls below a predetermined relevance threshold: deleting, by the one or more processors, the content group, or replacing, by the one or more processors, a resource identifier for the content group with the input resource identifier.
(9) The method of any one of (1) through (8), further including generating, by the one or more processors, digital content items for at least one content group of the plurality of content groups.
(10) The method of any one of (1) through (9), wherein providing the one or more content groups further includes: providing for output, by the one or more processors to a user interface, the one or more content groups; receiving, by the one or more processors, input confirming the one or more content groups for inclusion in a digital content campaign; and in response to receiving the input confirming the one or more content groups for inclusion in the content delivery campaign, generating, by the one or more processors, the content delivery campaign for a campaign management platform including the one or more content groups.
(11) The method of either (9) or (10), further including: receiving, by the one or more processors, input indicating a content group of the one or more content groups and further including input data for modifying, adding, or removing the indicated content group; and modifying, by the one or more processors, the indicated content group in accordance with the received input data.
(12) The method of any one of (1) through (12), wherein generating the plurality of content groups includes generating the plurality of content groups using one or more AI models.
(13) A system including one or more processors and memory, the system configured to perform, by the one or more processors, operations of the method of any one of (1) through (12).
(14) One or more computer-readable storage media storing instructions that are operable, when executed by one or more processors, to cause the one or more processors to perform operations as in any one of claims (1)-(12).
(15) The computer-readable storage media of (14), wherein the computer-readable storage media is non-transitory.
(16) One or more computer program products storing instructions that are operable, when executed by one or more processors, to cause the one or more processors to perform operations as in any one of claims (1)-(12).

### Example Computing Environments

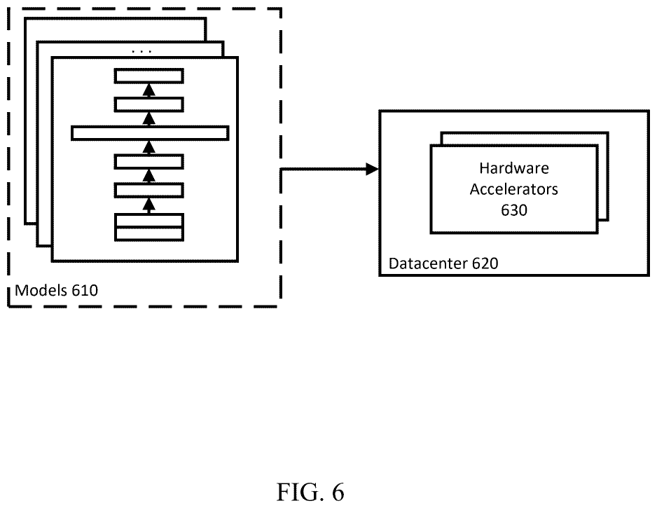

FIG. 6 is a block diagram illustrating one or more models 610, such as for deployment in a datacenter 620 housing one or more hardware accelerators 630 on which the deployed models will execute for content group generation. The hardware accelerators 630 can be any type of processor, such as a central processing unit (CPU), graphics processing unit (GPU), field-programmable gate array (FPGA), or an application-specific integrated circuit (ASIC), such as a tensor processing unit (TPU).

In some examples, the techniques disclosed herein enable artificial intelligence to generate content groups, keywords, and/or digital content. Artificial intelligence (AI) is a segment of computer science that focuses on the creation of models that can perform tasks with little to no human intervention. Artificial intelligence systems can utilize, for example, machine learning, natural language processing, and computer vision. Machine learning, and its subsets, such as deep learning, focus on developing models that can infer outputs from data. The outputs can include, for example, predictions and/or classifications. Natural language processing focuses on analyzing and generating human language. Computer vision focuses on analyzing and interpreting images and videos. Artificial intelligence systems can include generative models that generate new content, such as images, videos, text, audio, and/or other content, in response to input prompts and/or based on other information.

An architecture of a model can refer to characteristics defining the model, such as characteristics of layers for the model, how the layers process input, or how the layers interact with one another. For example, the model can be a convolutional neural network that includes a convolution layer that receives input data, followed by a pooling layer, followed by a fully connected layer that generates a result. The architecture of the model can also define types of operations performed within each layer. A model can be a composite of multiple models or components of a processing or training pipeline. In some examples, the models or components are trained separately, while in other examples, the models or components are trained end-to-end. One or more model architectures can be generated that can output results associated with content group generation for content delivery campaigns.

For example, the architecture of a convolutional neural network may define that rectified linear unit (ReLU) activation functions are used in the fully connected layer of the network. Other example architectures can include generative models, such as language models, foundation models, and/or graphical models. Yet other example architectures can include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some machine-learned models can include multi-headed self-attention models (e.g., transformer models).

The model(s) 610 can be trained using various training or learning techniques. The training can implement supervised learning, unsupervised learning, reinforcement learning, etc. The training can use techniques such as, for example, backwards propagation of errors. For example, a loss function can be backpropagated through the model(s) to update one or more parameters of the model(s) (e.g., based on a gradient of the loss function). For example, training data can include multiple training examples that can be received as input by a model. The training examples can be labeled with a desired output for the model when processing the labeled training examples. The label and the model output can be evaluated through a loss function to determine an error, which can be backpropagated through the model to update weights for the model. For example, a supervised learning technique can be applied to calculate an error between outputs, with a ground-truth label of a training example processed by the model.

Various loss functions can be used such as mean squared error, likelihood loss, cross entropy loss, hinge loss, and/or various other loss functions. Gradient descent techniques can be used to iteratively update the parameters over a number of training iterations. A number of generalization techniques (e.g., weight decays, dropouts) can be used to improve the generalization capability of the models being trained. The gradient of the error with respect to the different weights of the candidate model on candidate hardware can be calculated, for example using a backpropagation algorithm, and the weights or model parameter values for the model can be updated. The model can be trained until stopping criteria are met, such as a number of iterations for training, a maximum period of time, a convergence, or when a minimum accuracy threshold is met.

The model(s) 610 can be pre-trained before domain-specific alignment. For instance, a model can be pretrained over a general corpus of training data and fine-tuned on a more targeted corpus of training data. For example, the more targeted corpus of training data can include example input resource identifiers and descriptions for identifying themes of corresponding digital content identified by the resource identifier, for generating keyword lists and candidate content groups. As another example, the targeted corpus training data can include keyword lists for training a model to generate digital content items using the keyword lists. A model can be aligned using prompts that are designed to elicit domain-specific outputs. Prompts can be designed to include learned prompt values (e.g., soft prompts). The trained model(s) may be validated prior to their use using input data other than the training data and may be further updated, refined, or fine-tuned, during their use based on additional feedback or input.

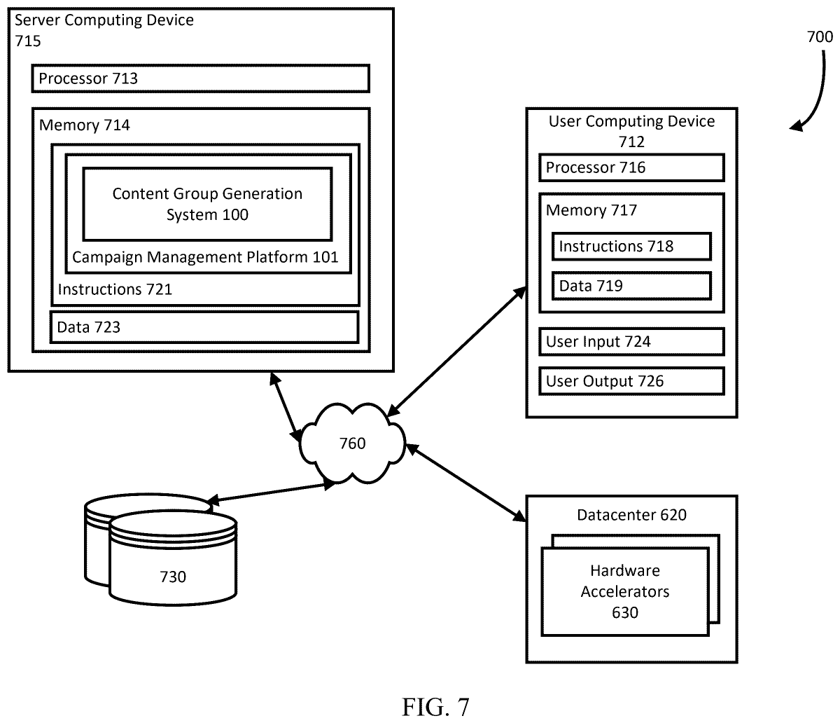

FIG. 7 is a block diagram of an example computing environment for implementing the content group generation system. The group content generation system 100 can be implemented on one or more devices having one or more processors in one or more locations, such as in server computing device 715. User computing device 712 and the server computing device 715 can be communicatively coupled to one or more storage devices 730 over a network 760. The storage device(s) 730 can be a combination of volatile and non-volatile memory and can be at the same or different physical locations than the computing devices 712, 715. For example, the storage device(s) 730 can include any type of non-transitory computer readable medium capable of storing information, such as a hard-drive, solid state drive, tape drive, optical storage, memory card, ROM, RAM, DVD, CD-ROM, write-capable, and read-only memories.

Aspects of the disclosure can be implemented in a computing system that includes a back-end component, e.g., as a data server, a middleware component, e.g., an application server, or a front-end component, e.g., user computing device 712 having a user interface, a web browser, or an app, or any combination thereof. The components of the system can be interconnected by any form or medium of digital data communication, such as a communication network. Examples of communication networks include a local area network (LAN) and a wide area network (WAN), e.g., the Internet. The datacenter 620 can also be in communication with the user computing device 712 and the server computing device 715.

While the system 100 is shown as part of campaign management platform 101 implemented by server computing device 715, it is understood that the campaign management platform 101, the system 100, and/or other components described herein can be implemented in any combination of hardware, firmware, and/or software in one or more computing devices in one or more physical locations.

The computing system can include clients, e.g., user computing device 712 and servers, e.g., server computing device 715. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

The server computing device 715 can include one or more processors 713 and memory 714. The memory 714 can store information accessible by the processor(s) 713, including instructions 721 that can be executed by the processor(s) 713. The memory 714 can also include data 723 that can be retrieved, manipulated, or stored by the processor(s) 713. The memory 714 can be a type of non-transitory computer readable medium capable of storing information accessible by the processor(s) 713, such as volatile and non-volatile memory. The processor(s) 713 can include one or more central processing units (CPUs), graphic processing units (GPUs), field-programmable gate arrays (FPGAs), and/or application-specific integrated circuits (ASICs), such as tensor processing units (TPUs).

The instructions 721 can include one or more instructions that when executed by the processor(s) 713, causes the one or more processors to perform actions defined by the instructions. The instructions 721 can be stored in object code format for direct processing by the processor(s) 713, or in other formats including interpretable scripts or collections of independent source code modules that are interpreted on demand or compiled in advance. The instructions 721 can include instructions for implementing the system 100 consistent with aspects of this disclosure. The system 100 can be executed using the processor(s) 713, and/or using other processors remotely located from the server computing device 715.

The data 723 can be retrieved, stored, or modified by the processor(s) 713 in accordance with the instructions 721. The data 723 can be stored in computer registers, in a relational or non-relational database as a table having a plurality of different fields and records, or as JSON, YAML, proto, or XML documents. The data 723 can also be formatted in a computer-readable format such as, but not limited to, binary values, ASCII, or Unicode. Moreover, the data 723 can include information sufficient to identify relevant information, such as numbers, descriptive text, proprietary codes, pointers, references to data stored in other memories, including other network locations, or information that is used by a function to calculate relevant data.

The user computing device 712 can also be configured similarly to the server computing device 715, with one or more processors 716, memory 717, instructions 718, and data 719. For example, the user computing device 712 can be a mobile device, a laptop, a desktop computer, a game console, etc. The user computing device 712 can also include a user output 726, and a user input 724. The user input 724 can include any appropriate mechanism or technique for receiving input from a user, including acoustic input; visual input; tactile input, including touch motion or gestures, or kinetic motion or gestures or orientation motion or gestures; auditory input, speech input, etc., Example devices for user input 724 can include a keyboard, mouse or other point device, mechanical actuators, soft actuators, touchscreens, microphones, and sensors.

The server computing device 715 can be configured to transmit data to the user computing device 712, and the user computing device 712 can be configured to display at least a portion of the received data on a display implemented as part of the user output 726. The user output 726 can also be used for displaying an interface between the user computing device 712 and the server computing device 715. The user output 726 can alternatively or additionally include one or more speakers, transducers or other audio outputs, a haptic interface or other tactile feedback that provides non-visual and non-audible information to the platform user of the user computing device 712.

Although FIG. 7 illustrates the processors 713, 716 and the memories 714, 717 as being within the computing devices 715, 712, components described in this specification, including the processors 713, 716 and the memories 714, 717 can include multiple processors and memories that can operate in different physical locations and not within the same computing device. For example, some of the instructions 721, 718 and the data 723, 719 can be stored on a removable SD card and others within a read-only computer chip. Some or all of the instructions and data can be stored in a location physically remote from, yet still accessible by, the processors 713, 716. Similarly, the processors 713, 716 can include a collection of processors that can perform concurrent and/or sequential operation. The computing devices 715, 712 can each include one or more internal clocks providing timing information, which can be used for time measurement for operations and programs run by the computing devices 715, 712.

The server computing device 715 can be configured to receive requests to process data from the user computing device 712. For example, the environment 700 can be part of a computing platform configured to provide a variety of services to users, through various user interfaces and/or APIs exposing the platform services. One or more services can be a machine learning framework or a set of tools for training or executing generative models or other machine learning models according to a specified task and training data.

The devices 712, 715 can be capable of direct and indirect communication over the network 760. The devices 715, 712 can set up listening sockets that may accept an initiating connection for sending and receiving information. The network 760 itself can include various configurations and protocols including the Internet, World Wide Web, intranets, virtual private networks, wide area networks, local networks, and private networks using communication protocols proprietary to one or more companies. The network 760 can support a variety of short-and long-range connections. The short- and long-range connections may be made over different bandwidths, such as 2.402 GHz to 2.480 GHz (commonly associated with the Bluetooth® standard), 2.4 GHz and 5 GHz (commonly associated with the Wi-Fi® communication protocol); or with a variety of communication standards, such as the LTE® standard for wireless broadband communication. The network 760, in addition or alternatively, can also support wired connections between the devices 712, 715, including over various types of Ethernet connection.

Although a single server computing device 715, user computing device 712, and datacenter 620 are shown in FIG. 7, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device, and any combination thereof.

Aspects of this disclosure can be implemented in digital electronic circuitry, in tangibly-embodied computer software or firmware, and/or in computer hardware, such as the structure disclosed herein, their structural equivalents, or combinations thereof. Aspects of this disclosure can further be implemented as one or more computer programs, such as one or more engines or modules of computer program instructions encoded on one or more tangible non-transitory computer storage media for execution by, or to control the operation of, one or more data processing apparatus.

A computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, that is generated to encode information for transmission to suitable receiver apparatus for execution by a data processing apparatus. A computer program may, but need not, correspond to a file in a file system. A computer program or computer program product can be stored in a portion of a file that holds other programs or data, e.g., one or more scripts, in a single file, or in multiple coordinated files, e.g., files that store one or more engines, modules, sub-programs, or portions of code.

The term “configured” is used herein in connection with systems and computer program components. For a system of one or more computers to be configured to perform particular operations or actions means that the system has installed software, firmware, hardware, or a combination thereof that cause the system to perform the operations or actions. For one or more computer programs to be configured to perform operations or actions means that the one or more programs include instructions that, when executed by one or more data processing apparatus, cause the apparatus to perform the operations or actions.

The term “data processing apparatus” refers to data processing hardware and encompasses various apparatus, devices, and machines for processing data, including programmable processors, a computer, or combinations thereof. The data processing apparatus can include special purpose logic circuitry, such as a field programmable gate array (FPGA) or an application specific integrated circuit (ASIC), such as a Tensor Processing Unit (TPU). The data processing apparatus can include code that creates an execution environment for computer programs, such as code that constitutes processor firmware, a protocol stack, a database management system, an operating system, or combinations thereof.

The data processing apparatus can include special-purpose hardware accelerator units for implementing machine learning models to process common and compute-intensive parts of machine learning training or production, such as inference or workloads. Machine learning models can be implemented and deployed using one or more machine learning frameworks, such as static or dynamic computational graph frameworks.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a standalone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “database” refers to any collection of data. The data can be unstructured or structured in any manner. The data can be stored on one or more storage devices in one or more locations. For example, an index database can include multiple collections of data, each of which may be organized and accessed differently.

The term “engine” can refer to a software-based system, subsystem, or process that is programmed to perform one or more specific functions. The engine can be implemented as one or more software modules or components or can be installed on one or more computers in one or more locations. A particular engine can have one or more processors or computing devices dedicated thereto, or multiple engines can be installed and running on the same processor or computing device. In some examples, an engine can be implemented as a specially configured circuit, while in other examples, an engine can be implemented in a combination of software and hardware.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers. While operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all examples, and it should be understood that the described program components and systems can be integrated together in one or more software or hardware-based devices or computer-readable media.

A computer or special purpose logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, desktop computer, a personal digital assistant (PDA), a mobile audio or video player, a game console, a tablet, a virtual-reality (VR) or augmented-reality (AR) device, a Global Positioning System (GPS), or a portable storage device, e.g., a universal serial bus (USB) flash drive, as examples. Examples of the computer or special purpose logic circuitry can include the user computing device 712, the server computing device 715, or the hardware accelerators 630.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks, DVD-ROM disks, or combinations thereof.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible examples. Further, the same reference numbers in different drawings can identify the same or similar elements.

1. A method for content group generation for a digital content delivery campaign, comprising:
receiving, by one or more processors, a request to generate a content delivery campaign, the request comprising an input resource identifier, wherein the input resource identifier identifies a source or location of digital content;
determining, by the one or more processors, one or more themes at least partially characterizing digital content at a source or location identified by the input resource identifier;
generating, by the one or more processors, a plurality of content groups, each content group comprising a respective set of keywords and a respective resource identifier corresponding to a respective theme, wherein the respective resource identifiers identify respective sources or locations of the digital content;
ranking, by the one or more processors, the plurality of content groups based at least on a respective request coverage gain for at least one content group of the plurality of content groups relative to other content groups in the plurality of content groups, wherein:
request coverage gain corresponds to a metric of increased or decreased request coverage of at least one content group of the plurality of content groups relative to other content groups in the plurality of content groups, and
the request coverage corresponds to a metric of the responsiveness of keywords of a content group to request for content;
selecting, by the one or more processors and based at least on the ranking, one or more content groups of the plurality of the content groups; and
in response to the request, providing, by the one or more processors, the one or more content groups.

2. The method of claim 1, wherein the request coverage gain further comprises the request coverage of keywords in a content group that do not overlap with keywords other content groups of the plurality of content groups.

3. The method of claim 1, wherein ranking the plurality of content groups comprises:
determining a first content group with the highest request coverage gain relative to other content groups of the plurality of content groups;
removing overlapping keywords from the other content groups, wherein overlapping keywords are one or more keywords that are in both the first content group and the other content groups; and
determining a second content group with the next highest request coverage from the other content groups with overlapping keywords removed.

4. The method of claim 3, further comprising performing one or more iterations of:
determining, by the one or more processors, a respective next content group from the other content groups with the highest request coverage gain; and
removing, by the one or more processors, keywords from the other content groups that overlap with keywords from the respective next content group.

5. The method of claim 1, wherein generating the plurality of content groups comprises:
determining, by the one or more processors, that a content group of the plurality of content groups comprises a respective resource identifier that is invalid; and
either:
removing, by the one or more processors, the content group with the respective resource identifier that is invalid, from the plurality of content groups; or
replacing, by the one or more processors, the respective resource identifier with the input resource identifier.

6. The method of claim 1, wherein:
the request further comprises an input description corresponding to the digital content at the resource identified by the input resource identifier; and
determining the one or more themes further comprises determining the one or more themes based at least on the digital content at the resource identified by the input resource identifier and the input description.

7. The method of claim 1, wherein ranking the plurality of content groups further comprises ranking in accordance with one or more of:
a content strength value measuring the adherence of digital content in a content group with one or more predetermined content guidelines,
a theme importance value measuring the relevance of a theme corresponding to a content group with one or more themes identified in the digital content located at the resource corresponding to the resource identifier, or
a theme to resource identifier relevance value measuring the relevance of a theme of a content group with digital content located at a resource corresponding to a resource identifier for the content group.

8. The method of claim 7, wherein ranking the plurality of content groups further comprises:
determining, by the one or more processors, that a theme to resource identifier relevance for a content group falls below a predetermined relevance threshold; and
in response to determining that a theme to resource identifier relevance for a content group falls below a predetermined relevance threshold:
deleting, by the one or more processors, the content group, or
replacing, by the one or more processors, a resource identifier for the content group with the input resource identifier.

9. The method of claim 1, further comprising generating, by the one or more processors, digital content items for at least one content group of the plurality of content groups.

10. The method of claim 1, wherein providing the one or more content groups further comprises:
providing for output, by the one or more processors to a user interface, the one or more content groups;
receiving, by the one or more processors, input confirming the one or more content groups for inclusion in a digital content campaign; and
in response to receiving the input confirming the one or more content groups for inclusion in the content delivery campaign, generating, by the one or more processors, the content delivery campaign for a campaign management platform comprising the one or more content groups.

11. The method of claim 9, further comprising:
receiving, by the one or more processors, input indicating a content group of the one or more content groups and further comprising input data for modifying, adding, or removing the indicated content group; and
modifying, by the one or more processors, the indicated content group in accordance with the received input data.

12. The method of claim 1, wherein generating the plurality of content groups comprises generating the plurality of content groups using one or more artificial intelligence (“AI”) models.

13. A system, comprising:
one or more processors configured to:
receive a request to generate a content delivery campaign, the request comprising an input resource identifier;
determine one or more themes at least partially characterizing digital content at the source of location identified by the input resource identifier;
generate a plurality of content groups, each content group comprising a respective set of keywords and a respective resource identifier corresponding to a respective theme, wherein the input resource identifier identifies a source or location of digital content;
rank the plurality of content groups based at least on a respective request coverage gain for at least one content group of the plurality of content groups relative to other content groups in the plurality of content groups, wherein:
request coverage gain corresponds to a metric of increased or decreased request coverage of at least one content group of the plurality of content groups relative to other content groups in the plurality of content groups, and
the request coverage corresponds to a metric of the responsiveness of keywords of a content group to request for content;
select, based at least on the ranking, one or more content groups of the plurality of the content groups; and
in response to the request, provide the one or more content groups.

14. The system of claim 13, wherein the request coverage gain further comprises the request coverage of keywords in a content group that do not overlap with keywords other content groups of the plurality of content groups.

15. The system of claim 13, wherein in ranking the plurality of content groups, the one or more processors are configured to:
determine a first content group with the highest request coverage gain relative to other content groups of the plurality of content groups;
remove overlapping keywords from the other content groups, wherein overlapping keywords are one or more keywords that are in both the first content group and the other content groups; and
determine a second content group with the next highest request coverage from the other content groups with overlapping keywords removed.

16. The system of claim 14, wherein the one or more processors are configured to perform one or more iterations of:
determining a respective next content group from the other content groups with the highest request coverage gain; and
removing keywords from the other content groups that overlap with keywords from the respective next content group.

17. The system of claim 13, wherein in generating the plurality of content groups, the one or more processors are configured to:
determine that a content group of the plurality of content groups comprises a respective resource identifier that is invalid; and
either:
remove the content group with the respective resource identifier that is invalid, from the plurality of content groups; or
replace the respective resource identifier with the input resource identifier.

18. The system of claim 13, wherein:
the request further comprises an input description corresponding to the digital content at the resource identified by the input resource identifier; and
in determining the one or more themes, the one or more processors are further configured to determine the one or more themes based at least on the digital content at the resource identified by the input resource identifier and the input description.

19. The system of claim 13, wherein in ranking the plurality of content groups, the one or more processors are further configured to rank the plurality of content groups in accordance with one or more of:
a content strength value measuring the adherence of digital content in a content group with one or more predetermined content guidelines,
a theme importance value measuring the relevance of a theme corresponding to a content group with one or more themes identified in the digital content located at the resource corresponding to the resource identifier, or
a theme to resource identifier relevance value measuring the relevance of a theme of a content group with digital content located at a resource corresponding to a resource identifier for the content group.

20. One or more non-transitory computer-readable storage media storing instructions that are operable, when executed by one or more processors, to cause the one or more processors to perform operations comprising:
receiving a request to generate a content delivery campaign, the request comprising an input resource identifier, wherein the input resource identifier identifies a source of location of digital content;
determining one or more themes at least partially characterizing digital content at the source or location identified by the input resource identifier;
generating a plurality of content groups, each content group comprising a respective set of keywords and a respective resource identifier corresponding to a respective theme, wherein the respective resource identifiers identify respective sources or locations of the digital content;
ranking the plurality of content groups based at least on a respective request coverage gain for at least one content group of the plurality of content groups relative to other content groups in the plurality of content groups, wherein:
request coverage gain corresponds to a metric of increased or decreased request coverage of at least one content group of the plurality of content groups relative to other content groups in the plurality of content groups, and
the request coverage corresponds to a metric of the responsiveness of keywords of a content group to request for content;
selecting, based at least on the ranking, one or more content groups of the plurality of the content groups; and
in response to the request, providing the one or more content groups.
